(19) United States
(12) Patent Application Publication
(10) Pub. No.: US 2014/0250277 A1
(43) Pub. Date: Sep. 4, 2014

(54) MEMORY SYSTEM

(71) Applicant: Kabushiki Kaisha Toshiba, Minato-ku (JP)

(72) Inventors: Akinori Harasawa, Kunitachi-shi (JP); Yoshimasa Aoyama, Kawasaki-shi (JP)

(73) Assignee: Kabushiki Kaisha Toshiba, Minato-ku (JP)

(21) Appl. No.: 13/903,111

(22) Filed: May 28, 2013

Related U.S. Application Data
(60) Provisional application No. 61/772,244, filed on Mar. 4, 2013.

(51) Int. Cl. G06F 3/06

(52) U.S. Cl. CPC G06F 3/0688; G06F 3/0644; G06F 3/0608
USPC 711/153

(57) ABSTRACT

According to one embodiment, a memory system comprises a storage areas each having a physical page that is data-write- and read-accessible, the storage areas being divided into a plurality of parallel operation elements capable of performing a parallel operation, and the physical pages of the storage areas being associated with a logical page, a storage unit having a first buffer configured to store data to be rewritten in the storage areas, and a control unit configured to perform data transfer between the storage areas and the storage unit. The control unit comprises a logical page management unit configured to divide the logical page in a predetermined number of parallel operation elements out of the plurality of parallel operation elements, and a system control unit configured to perform a predetermined operation in each of the divided logical pages.

### CROSS-REFERENCE TO RELATED APPLICATIONS

This application claims the benefit of U.S. Provisional Application No. 61/772,244, filed Mar. 4, 2013, the entire contents of which are incorporated herein by reference.

### FIELD

Embodiments described herein relate generally to a memory system.

### BACKGROUND

In recent years, development of a solid-state drive (SSD) as a data storage device using a NAND flash memory (to also be simply referred to as a flash memory hereinafter) that is a rewritable nonvolatile (or non-transitory) memory is being pushed forward.

### BRIEF DESCRIPTION OF THE DRAWINGS

FIG. 1 is a block diagram showing an example of the arrangement of a memory system according to the first embodiment;

FIG. 2 is a view schematically showing the data management unit of NAND memories according to the first embodiment;

FIG. 3 is a view showing an example of the arrangement of a logical page of the NAND memories according to the first embodiment;

FIG. 4 is a conceptual view for explaining compaction processing according to the first embodiment;

FIG. 5 is a timing chart showing compaction processing according to a comparative example;

FIGS. 6, 7, and 8 are schematic views showing a memory system so as to explain the compaction processing according to the comparative example;

FIG. 9 is a timing chart showing compaction processing according to the first embodiment;

FIGS. 10, 11, 12, 13, 14, and 15 are schematic views showing a memory system so as to explain the compaction processing according to the first embodiment;

FIG. 16 is a timing chart showing host write according to the second embodiment;

FIGS. 17, 18, and 19 are schematic views showing a memory system so as to explain the host write according to the second embodiment;

FIG. 20 is a view for explaining the mechanism of bank interleave according to the third embodiment; and

FIG. 21 is a timing chart showing host write and compaction write using bank interleave according to the third embodiment.

### DETAILED DESCRIPTION

In an SSD, as data rewrite in the flash memory progresses, the ratio of storage areas incapable of storing valid data rises because of invalid data (data that is not latest). For this reason, the SSD executes compaction processing to effectively use the storage areas in each block. The compaction processing is also called garbage collection. Invalid data (data that is not latest) indicates data that is never referred to again because data of the same logical address is written at another physical address. Valid data indicates data written at a physical address associated with a logical address.

In the SSD, the NAND memory is formed from a plurality of parallel operation elements (channels) capable of performing a parallel operation. Each channel has physical pages as units that are data-write- and read-accessible. A logical page is formed by the physical pages of all channels capable of the parallel operation.

When a logical page is formed over all channels, as described above, read (compaction read) and write (compaction write) in the compaction processing are operated for all channels. For this reason, scheduling for simultaneously operating the compaction read and compaction write is difficult, and compaction performance degrades.

In addition, if the simultaneous operation of the compaction read and compaction write is difficult, and pipeline processing cannot be performed, the amount of data that should be accumulated in the compaction buffer by the compaction read increases. That is, the capacity of the compaction buffer needs to be increased, affecting the chip area and cost.

In general, according to one embodiment, a memory system comprises: a storage areas each having a physical page that is data-write- and read-accessible, the storage areas being divided into a plurality of parallel operation elements capable of performing a parallel operation, and the physical pages of the storage areas being associated with a logical page; a storage unit having a first buffer configured to store data to be rewritten in the storage areas; and a control unit configured to perform data transfer between the storage areas and the storage unit. The control unit comprises: a logical page management unit configured to divide the logical page in a predetermined number of parallel operation elements out of the plurality of parallel operation elements; and a system control unit configured to perform a predetermined operation in each of the divided logical pages.

The embodiments will now be described with reference to the accompanying drawings. The same reference numerals denote the same parts throughout the drawings. Note that a repetitive explanation will be made as needed.

### First Embodiment

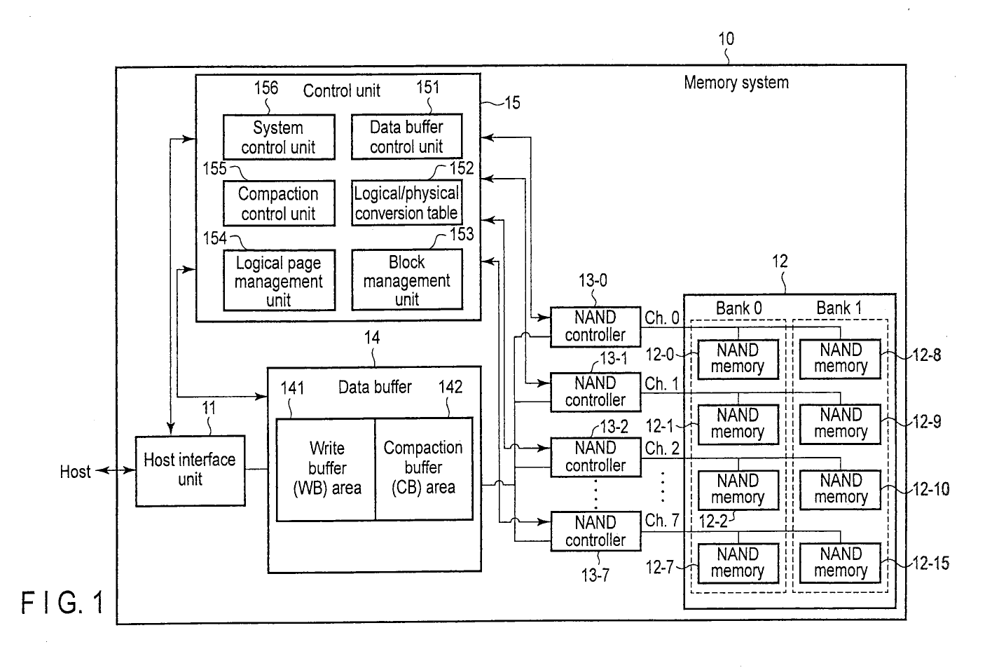

A memory system according to the first embodiment will be described with reference to FIGS. 1, 2, 3, 4, 5, 6, 7, 8, 9, 10, 11, 12, 13, 14, and 15. In the first embodiment, a logical page is divided into a predetermined number of channels Ch, and compaction processing is performed while overlapping processes between the divided logical pages. This allows to improve compaction performance and decrease the capacity of a compaction buffer. The first embodiment will be described below in detail.

### [Example of Arrangement of Memory System]

FIG. 1 is a block diagram showing an example of the arrangement of a memory system according to the first embodiment. A memory system 10 is, for example, an SSD including a nonvolatile memory as an external storage device used in a computer system. An example will be explained below in which a NAND flash memory is used as the nonvolatile memory.

As shown in FIG. 1, the memory system 10 comprises a host interface unit 11, a first storage unit 12 including NAND memories 12-0 to 12-15, a NAND controller (channel control unit) 13, a data buffer 14 serving as a second storage unit, and a control unit 15.

The host interface unit 11 controls transfer of data, commands, and addresses between a host and the memory system 10. In this case, the host is, for example, a computer including an interface complying with the Serial Advanced Technology Attachment (BATA) or PCIe standard. The host interface unit 11 stores data (write data or the like) transferred from the host in the data buffer 14. The host interface unit 11 also transfers a command or an address transferred from the host to the control unit 15.

The data buffer 14 is a buffer memory formed from, for example, a dynamic random access memory (DRAM). Note that the data buffer 14 need not always be a DRAM and may employ a volatile random access memory of another type such as a static random access memory (SRAM). Alternatively, the data buffer 14 may employ a nonvolatile random access memory such as a magnetoresistive random access memory (MRAM) or a ferroelectric random access memory (FeRAM).

The data buffer 14 includes a write buffer (WB) area 141 and a compaction buffer (CB) area 142. The WB area 141 temporarily stores write data (user data) transferred from the host. The CB area 142 temporarily stores write data (valid data) at the time of compaction processing. Note that the data buffer 14 may include an area to store a logical/physical address conversion table. “Temporarily” indicates, for example, the interface processing period between two devices, which is a period shorter than the storage period of the first storage unit 12.

The control unit 15 is formed from, for example, a microprocessor (MPU), and executes main control of the memory system 10. The control unit 15 includes a data buffer control unit 151, a logical/physical conversion table 152, a block management unit 153, a logical page management unit 154, a compaction control unit 155, and a system control unit 156.

The data buffer control unit 151 manages and controls the data buffer 14. More specifically, the data buffer control unit 151 manages and controls data stored in the WB area 141 and the CB area 142, the free capacity of the WB area 141 and the CB area 142, and the like. The data buffer control unit 151 transfers information of the WB area 141 and the CB area 142 to the system control unit 156.

The logical/physical conversion table 152 represents the relationship between the logical address and the physical address of data.

The block management unit 153 manages the state and valid cluster of each block (logical block) of NAND memories 12-0 to 12-15 using a block management table. The block management table stores management information such as a block ID to identify each block, the state of each block, and the number of write completion pages. The state of a block indicates one of Active, Writing, and Free. That is, in the block management table, a free block indicates an unused block capable of write. A block incapable of write because of a failure is called a bad block.

The logical page management unit 154 manages the arrangement of a logical page of the first storage unit 12, which is a processing unit in the operation. More specifically, the logical page management unit 154 divides a logical page of the first storage unit 12 into a predetermined number of parallel operation elements out of a plurality of parallel operation elements (channels Ch0 to Ch7) to be described later and manages them. Details of division of the logical page of the first storage unit 12 will be described later.

The compaction control unit 155 controls compaction processing. The compaction control unit 155 executes compaction source block (compaction target block) search processing, processing of searching for a valid cluster (valid data in each cluster) in a block, valid cluster count processing, processing of generating compaction commands, and the like. The compaction commands indicate a read command (compaction read command) to execute read processing for compaction processing and a write command (compaction write command) to execute write processing for compaction processing. The compaction control unit 155 transfers the generated compaction commands to the system control unit 156.

The system control unit 156 controls the entire memory system 10. The system control unit 156 executes a read operation and a write operation by the host in accordance with a read command (host read command) and a write command (host write command) transferred from the host via the host interface unit 11. The system control unit 156 also executes a read operation and a write operation in compaction processing in accordance with a compaction read command and a compaction write command from the compaction control unit 155. Details of the read operation and the write operation in compaction processing will be described later.

The first storage unit 12 is formed from the plurality of NAND flash memories (to be simply referred to as NAND memories hereinafter) 12-0 to 12-15. The first storage unit 12 is a storage device capable of nonvolatilely storing data and is used as a storage unit to save user data, programs, management information for managing the data storage positions (recording positions) in the memory system 10, and the like. More specifically, the first storage unit 12 stores data designated by the host or stores important data to be nonvolatilely saved, such as management information for managing data recording positions in NAND memories 12-0 to 12-15 and firmware programs.

The plurality of NAND memories 12-0 to 12-15 are divided into a plurality of parallel operation elements (channels Ch0 to Ch7) that perform a parallel operation. The plurality of channels Ch0 to Ch7 are connected to NAND controllers 13-0 to 13-7, respectively. That is, the plurality of NAND memories 12-0 to 12-15 are divided into channels Ch0 to Ch7 by the connected NAND controllers 13-0 to 13-7. In this example, channel Ch0 is formed from NAND memories 12-0 and 12-8 connected to NAND controller 13-0, channel Ch1 is formed from NAND memories 12-1 and 12-9 connected to NAND controller 13-1, . . . , and channel Ch7 is formed from NAND memories 12-7 and 12-15 connected to NAND controller 13-7.

The plurality of NAND memories 12-0 to 12-15 are divided by a plurality of banks (in this case, two banks Bank 0 and Bank 1) capable of bank interleave. In this example, Bank 0 is formed from NAND memories 12-0 to 12-7, and Bank 1 is formed from NAND memories 12-8 to 12-15. That is, Bank 0 and Bank 1 are arranged across channels Ch0 to Ch7. In other words, the plurality of NAND memories 12-0 to 12-15 are arranged in a matrix by channels Ch0 to Ch7 and Bank 0 and Bank 1.

Each of NAND memories 12-0 to 12-15 can correspond to one NAND memory chip. Alternatively, out of NAND memories 12-0 to 12-15, memories connected to the same channel and belonging to adjacent banks, for example, NAND memories 12-0 and 12-8 may constitute one NAND memory chip. In the above-described example, the number of channels is 8, and the number of banks for each channel is 2. However, the number of channels and the number of banks are not limited to those. As described above, NAND memories 12-0 to 12-15 can perform a parallel operation by the plurality of channels and also perform a parallel operation by the bank interleave operation of the plurality of banks.

The NAND controller 13 performs interface processing (control of the difference in the operation timing, signal voltage, data representation method, and the like) between the first storage unit 12 and the units (the data buffer 14 and the control unit 15).

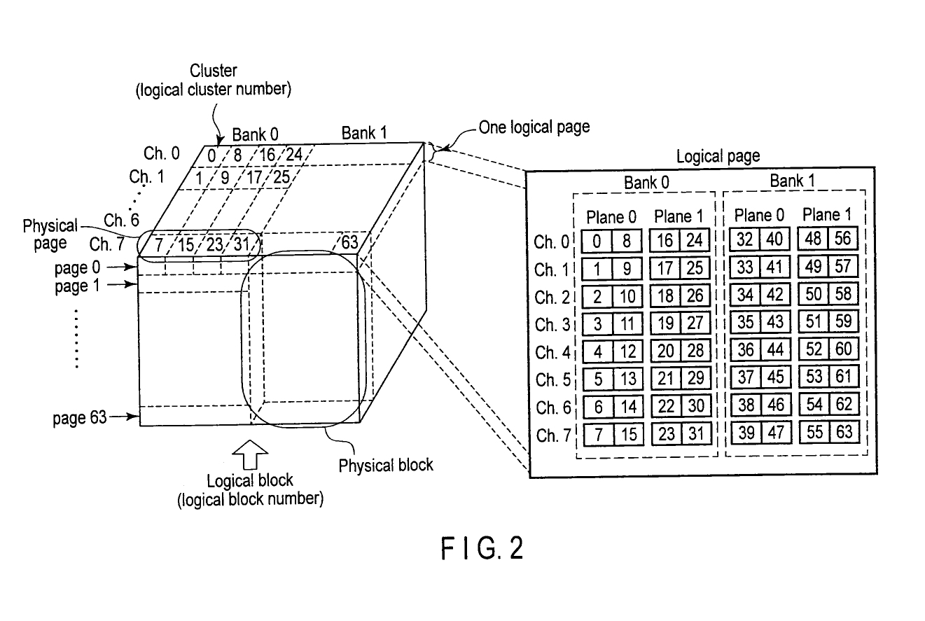

FIG. 2 is a view schematically showing the data management unit of the NAND memories according to the first embodiment.

As shown in FIG. 2, each of NAND memories 12-0 to 12-15 (NAND memory chips, storage areas) includes a plurality of physical pages that are read- and write-accessible at once. Each of NAND memories 12-0 to 12-15 includes a plurality of physical blocks each serving as a unit that is independently erase-accessible (a unit capable of individually performing an erase operation) and is formed from a plurality of physical pages (for example, page 0 to page 63). As described above, in this example, the parallel operation can be performed for each of channels Ch0 to Ch7, and the parallel operation by bank interleave can be performed for each of Bank 0 and Bank 1. Hence, 16 (8 channels× 2 banks) physical pages (page 0) of NAND memories 12-0 to 12-15 capable of write/read parallelly at once (by a series of operations) are associated with one logical page (for example, page 0) serving as a data recording area. In addition, 16 physical blocks capable of erase parallelly almost at once constitute one logical block serving as a data block.

Each of Bank 0 and Bank 1 has a plurality of planes Plane 0 and Plane 1 simultaneously accessible in the same memory chip. The planes Plane 0 and Plane 1 are arranged across channels Ch0 to Ch7. Note that different planes Plane 0 and Plane 1 in the same memory chip are also simultaneously accessible in some cases (multi-plane access).

Data in NAND memories 12-0 to 12-15 are managed (recorded) by clusters that are data management units smaller than the physical page. The cluster size is equal to or larger than the size of a sector that is the minimum access unit from the host. It is defined that a natural number multiple of the cluster size is the physical page size. More specifically, one physical page is formed from four clusters. One logical page is formed from 64 clusters. Note that in this example, since data write is performed parallelly at once in each channel, the data is stored in each cluster in a direction running across channels Ch0 to Ch7. In other words, the data is stored across all channels Ch0 to Ch7.

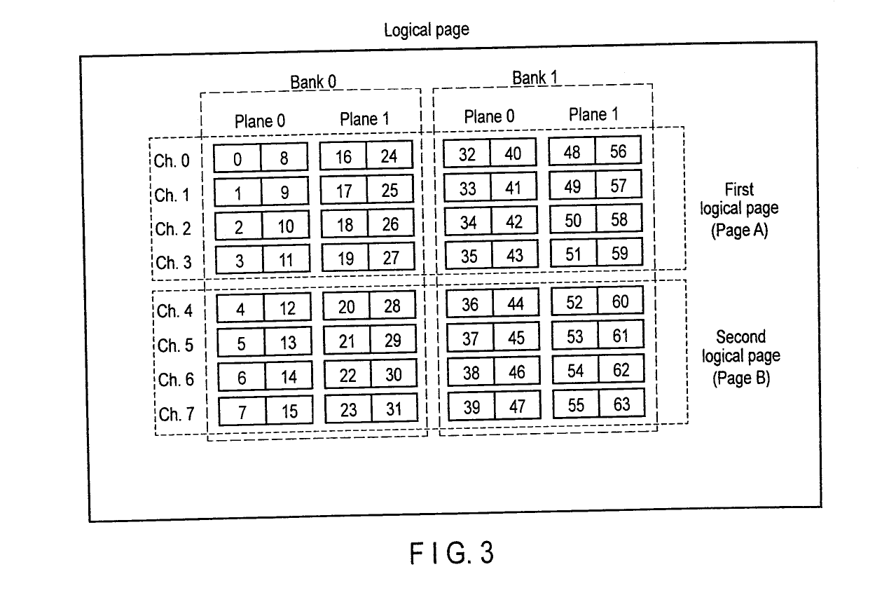

FIG. 3 is a view showing an example of the arrangement of a logical page of the NAND memories according to the first embodiment.

As shown in FIG. 3, in the first embodiment, the logical page management unit 154 divides a logical page into a first logical page A and a second logical page B. In other words, one logical page is reconstructed to a plurality of logical pages. The first logical page A is formed from channels Ch0 to Ch3, and the second logical page B is formed from channels Ch4 to Ch7. That is, one logical page having the eight channels Ch0 to Ch7 is divided along the channel direction into two logical pages each having four channels. Dividing along the channel direction indicates dividing a logical page including the plurality of channels Ch into a plurality of logical pages each having one or a predetermined number of channels Ch.

Note that the logical page is not necessarily divided into two logical pages, that is, the first logical page A and the second logical page B. In addition, the number of channels in each of the first logical page A and the second logical page B is not limited to 4, and they may have different numbers of channels.

In the first embodiment, the logical page is divided into the first logical page A and the second logical page B. This allows to independently perform compaction processing.

### [Compaction Processing]

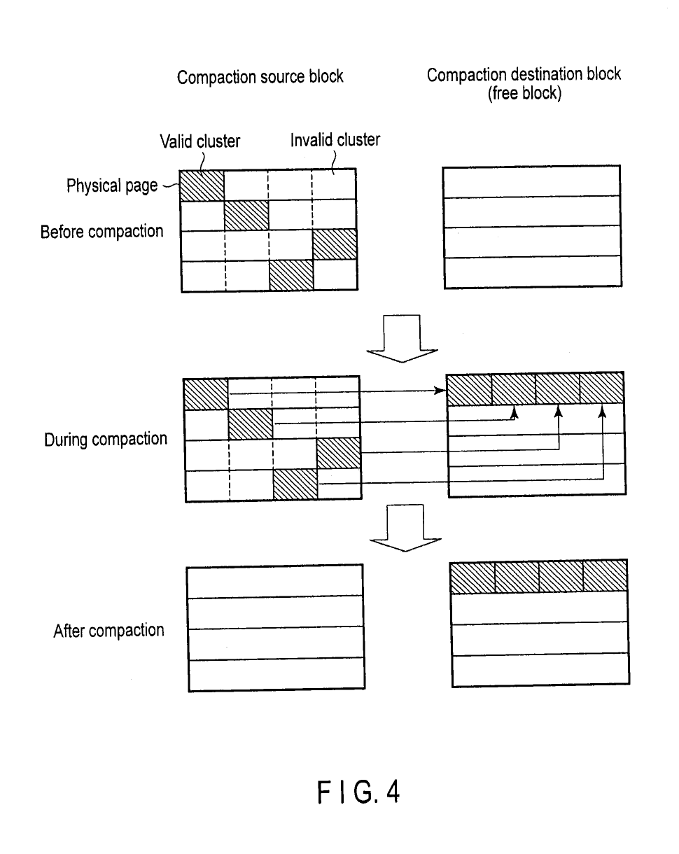

FIG. 4 is a conceptual view for explaining compaction processing according to the first embodiment. In the compaction processing of this embodiment, scattered valid data are collected and rewritten, thereby ensuring a writable area. This will be explained below in more detail.

As shown in FIG. 4, the compaction control unit 155 first searches NAND memories 12-0 to 12-15 for compaction source blocks. A compaction source block indicates a compaction processing target block in which the density of valid data (latest data) storage areas is low among active blocks where valid data are recorded. The compaction control unit 155 acquires information used to set compaction source block candidates from the block management unit 153. In this case, for effective compaction processing, a low-density block in which the number of valid clusters is as small as possible is preferably searched for as a compaction source block.

Next, the compaction control unit 155 searches for and counts valid clusters in the found compaction source blocks. Each block normally stores log information (not shown) to determine valid clusters and invalid clusters (invalid data).

The compaction control unit 155 generates a compaction command to execute compaction processing and transfers it to the system control unit 156. The system control unit 156 executes compaction processing based on the compaction command from the compaction control unit 155.

More specifically, the system control unit 156 performs compaction read of reading a valid cluster from each compaction source block in accordance with a compaction read command from the compaction control unit 155. The system control unit 156 also performs compaction write of writing, in a compaction destination block, each valid cluster read from each compaction source block. The compaction destination block indicates a free block selected from the list of the block management table managed by the block management unit 153.

With the above-described compaction processing, valid clusters (valid data in clusters) are collected from each compaction source block and rewritten in the compaction destination block. After the rewrite processing, the compaction source block is made reusable as a free block by erase processing. Even in the block in which the valid data are written by the movement, if there is a page in which no write has been done, the write can be performed newly for the page.

The compaction processing according to the first embodiment will be described below in more detail.

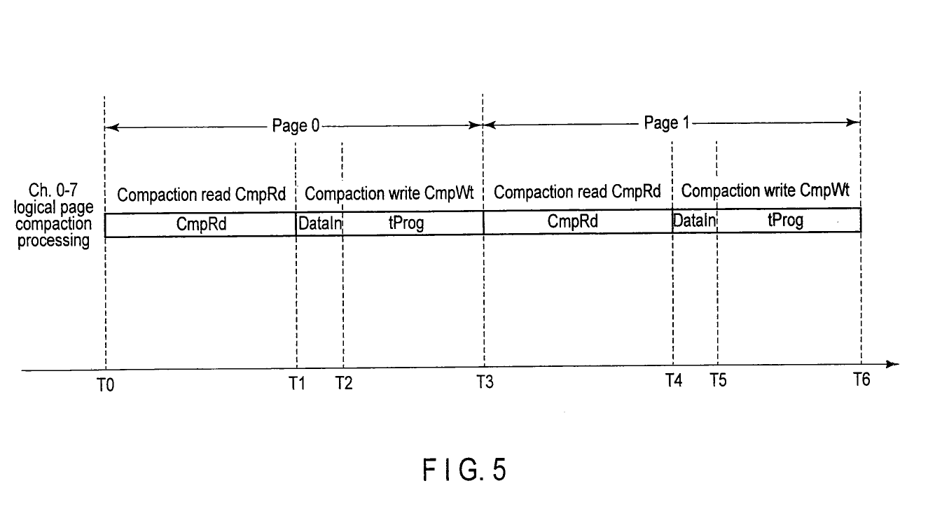

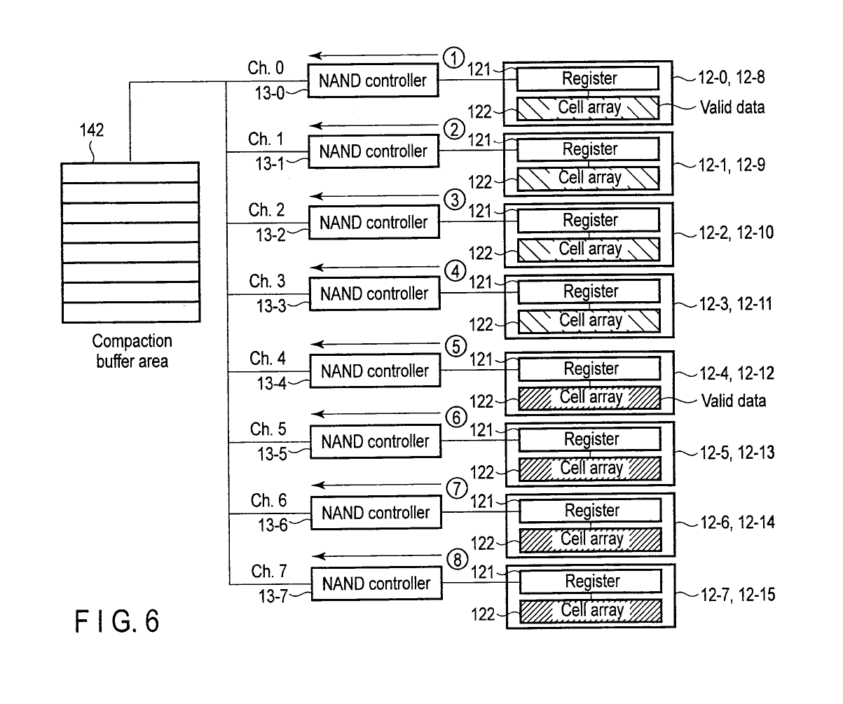

FIG. 5 is a timing chart showing compaction processing according to a comparative example. FIGS. 6, 7, and 8 are schematic views showing a memory system so as to explain the compaction processing according to the comparative example. In the compaction processing according to the comparative example, the processing is executed in the eight channels Ch0 to Ch7 without dividing the logical page. FIG. 5 shows compaction processing of two logical pages in page 0 and page 1.

As shown in FIG. 5, compaction processing of the logical page in page 0 is performed from time T0 to T3.

More specifically, at time T0, the system control unit 156 starts compaction read CmpRd of the logical page in page 0 based on a compaction read command transferred from the compaction control unit 155. Compaction target data corresponding to one logical page (page 0) are thus read from NAND memories 12-0 to 12-15 as the compaction sources via NAND controllers 13-0 to 13-7. At this time, the compaction target data are read sequentially in channels Ch0 to Ch7, as shown in FIG. 6. The read compaction target data are temporarily stored in the CB area 142 of the data buffer 14. After that, at time T1, the compaction target data are accumulated in the CB area 142, and the compaction read CmpRd of the logical page in page 0 ends. Note that the compaction read CmpRd indicates processing of transferring data from registers 121 of NAND memories 120 to 12-15 to the CB area 142.

Sequentially, at time T1, the system control unit 156 starts compaction write CmpWt of the logical page in Page 0 based on a compaction write command transferred from the compaction control unit 155.

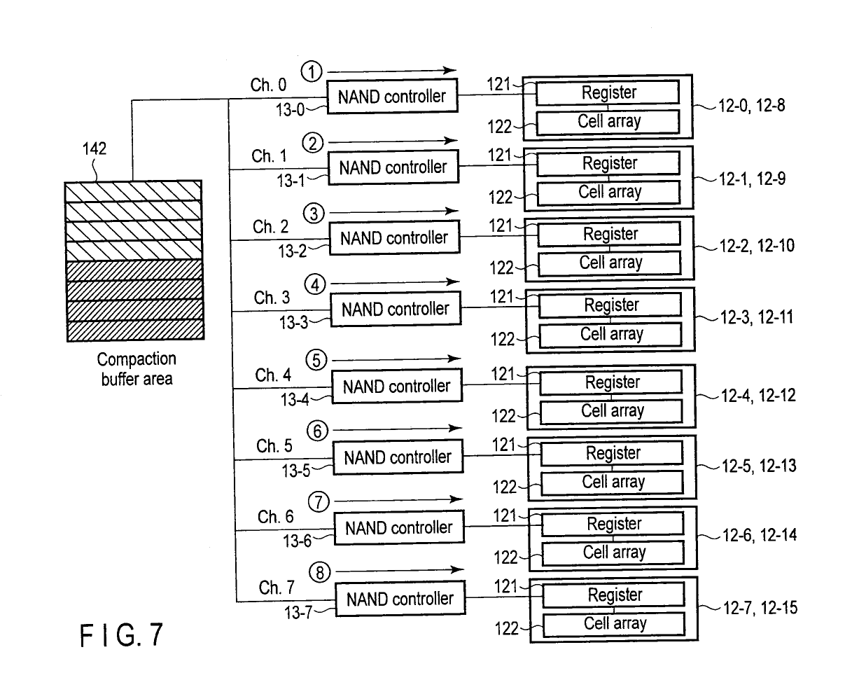

More specifically, at time T1, register transfer DataIn starts to transfer the compaction target data corresponding to one logical page from the CB area 142 to the registers 121 of NAND memories 12-0 to 12-15 as the compaction destinations via NAND controllers 13-0 to 13-7. At this time, the compaction target data are transferred sequentially in channels Ch0 to Ch7, as shown in FIG. 7. Note that although the register transfer DataIn is performed while setting all channels Ch0 to Ch7 as the compaction destinations in this example, the compactions are not limited to those. After that, at time T2, the compaction target data are transferred to the registers 121, and the register transfer DataIn ends.

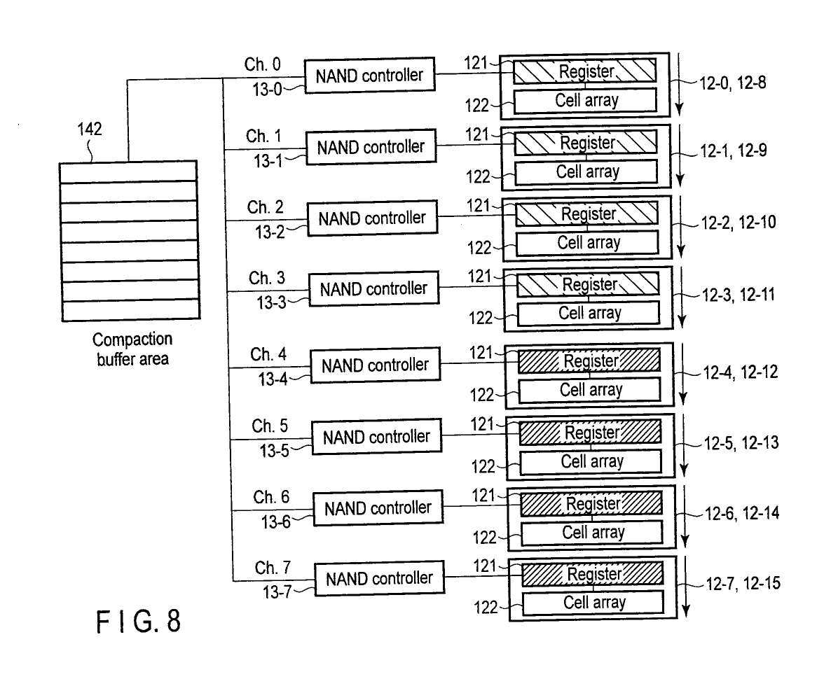

Next, at time T2, a cell array program tProg starts to write the compaction target data transferred to the registers 121 in cell arrays 122 of NAND memories 12-0 to 12-15. At this time, the compaction target data are parallelly written in channels Ch0 to Ch7, as shown in FIG. 8. After that, at time T3, the compaction target data are written in the cell arrays, and the cell array program tProg ends. That is, the compaction write CmpWt of the logical page in page 0 ends, and the compaction processing of the logical page in page 0 ends.

Next, compaction processing of the logical page in page 1 is performed from time T3 to T6, like the logical page in page 0.

More specifically, at time T3, the system control unit 156 starts the compaction read CmpRd of the logical page in page 1 based on a compaction read command transferred from the compaction control unit 155. Compaction target data corresponding to one logical page (page 1) are thus read from NAND memories 12-0 to 12-15 as the compaction sources via NAND controllers 13-0 to 13-7 and temporarily stored in the CB area 142 of the data buffer 14. After that, at time T4, the compaction target data are accumulated in the CB area 142, and the compaction read CmpRd of the logical page in page 1 ends.

Sequentially, at time T4, the system control unit 156 starts the compaction write CmpWt of the logical page in page 1 based on a compaction write command transferred from the compaction control unit 155.

More specifically, at time T4, the register transfer DataIn starts to transfer the compaction target data corresponding to one logical page from the CB area 142 to the registers 121 of NAND memories 12-0 to 12-15 as the compaction destinations via NAND controllers 13-0 to 13-7. After that, at time T5, the compaction target data are transferred to the registers 121, and the register transfer DataIn ends.

Next, at time T5, the cell array program tProg starts to write the compaction target data transferred to the registers 121 in the cell arrays 122 of NAND memories 12-0 to 12-15. After that, at time T6, the compaction target data are written in the cell arrays, and the cell array program tProg ends. That is, the compaction write CmpWt of the logical page in page 1 ends, and the compaction processing of the logical page in page 1 ends.

After that, compaction processing of logical page in page 2 and sequential pages is performed in a similar manner.

As described above, according to the comparative example, since the logical page is formed across channels Ch0 to Ch7, the compaction read CmpRd is performed for all channels Ch0 to Ch7, and after that, the compaction write CmpWt is sequentially performed for all channels Ch0 to Ch7. For this reason, the compaction read CmpRd and the compaction write CmpWt cannot be simultaneously performed (overlapped) in parallel. In other words, the compaction read CmpRd and the compaction write CmpWt cannot be performed by pipeline processing. In addition, it is necessary to store the compaction target data corresponding to one logical page in the data buffer 14 (CB area 142) by the compaction read CmpRd. For this reason, the capacity of the data buffer 14 increases.

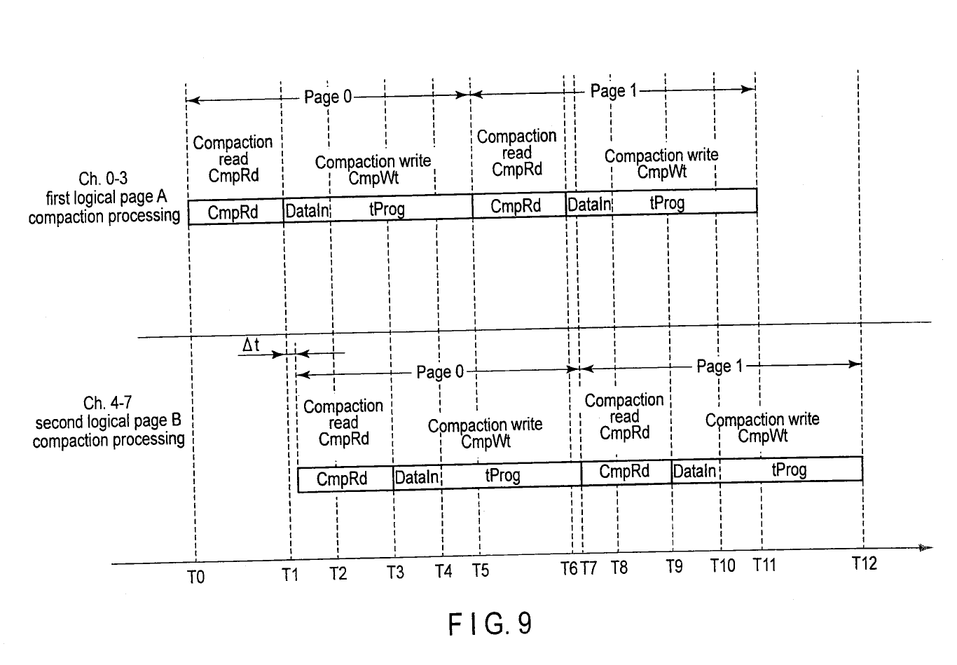

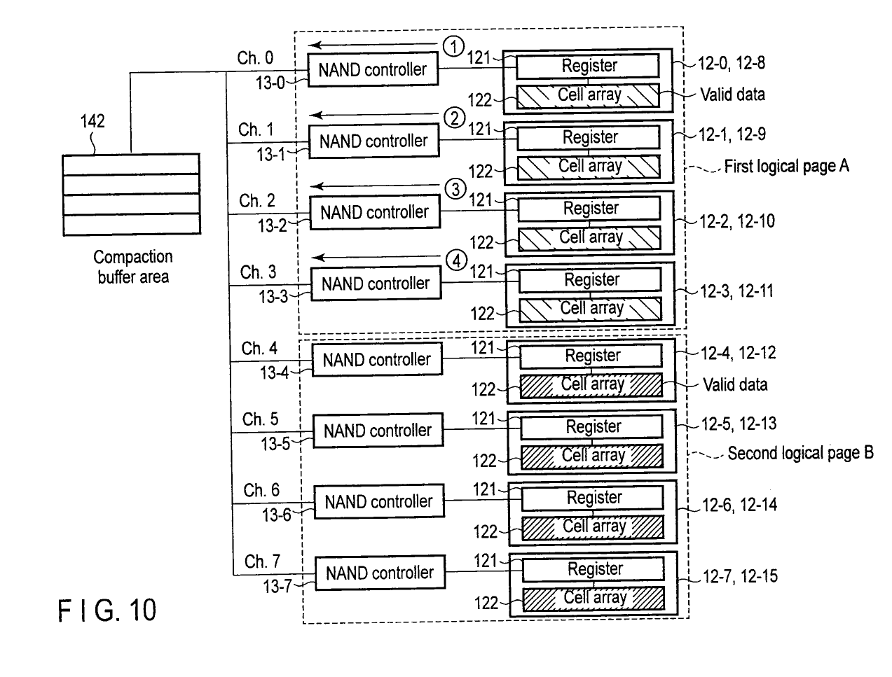

On the other hand, FIG. 9 is a timing chart showing compaction processing according to the first embodiment. FIGS. 10, 11, 12, 13, 14, and 15 are schematic views showing a memory system so as to explain the compaction processing according to the first embodiment. In the compaction processing according to the first embodiment, the logical page is divided into the first logical page A and the second logical page B, and the processes are simultaneously performed in parallel between the four channels Ch0 to Ch3 and channels Ch4 to Ch7. FIG. 9 also shows compaction processing of two logical pages in page 0 and page 1. Note that times T0 to T12 in FIG. 9 are not necessarily the same as times T0 to T6 in FIG. 5.

As shown in FIG. 9, compaction processing of the first logical page A (channels Ch0 to Ch3) of the logical page in page 0 (to be simply referred to as the first logical page A of page 0 hereinafter) is performed from time T0 to T5.

More specifically, at time T0, the system control unit 156 starts the compaction read CmpRd of the first logical page A of page 0 divided by the logical page management unit 154 based on a compaction read command transferred from the compaction control unit 155. Compaction target data corresponding to half of one logical page are thus read from NAND memories 12-0 to 12-3 and 12-8 to 12-11 as the compaction sources via NAND controllers 13-0 to 13-3. At this time, the compaction target data are read sequentially in channels Ch0 to Ch3, as shown in FIG. 10. The read compaction target data are temporarily stored in the CB area 142 of the data buffer 14. After that, at time T1, the compaction target data are accumulated in the CB area 142, and the compaction read CmpRd of the first logical page A of page 0 ends.

At this time, the processing data amount (number of channels) of the compaction read CmpRd according to the first embodiment is half of the processing data amount (number of channels) of the compaction read CmpRd according to the comparative example. As described above, the data are sequentially read on the channel basis in the compaction read CmpRd. For this reason, the time necessary for the compaction read CmpRd of the first embodiment (for example, the time from time T0 to T1 in FIG. 9) is half of the time necessary for the compaction read CmpRd of the comparative example (for example, the time from time T0 to T1 in FIG. 5).

Sequentially, at time T1, the system control unit 156 starts the compaction write CmpWt of the first logical page A of page 0 divided by the logical page management unit 154 based on a compaction write command transferred from the compaction control unit 155.

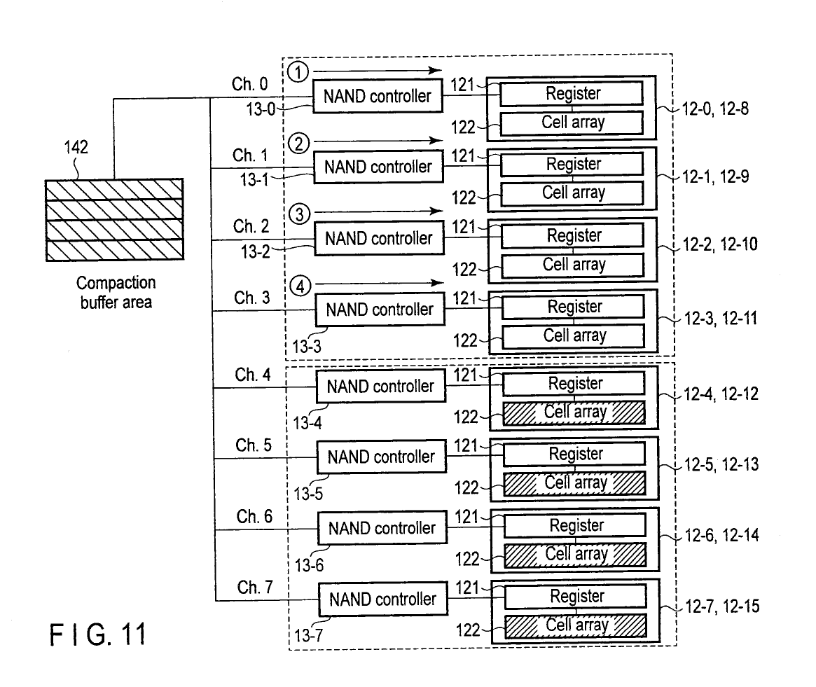

More specifically, at time T1, the register transfer DataIn of the first logical page A of page 0 starts to transfer the compaction target data corresponding to half of one logical page from the CB area 142 to the registers 121 of NAND memories 12-0 to 12-3 and 12-8 to 12-11 (first logical page A) as the compaction destinations via NAND controllers 13-0 to 13-3. At this time, the compaction target data are transferred sequentially in channels Ch0 to Ch3, as shown in FIG. 11. Note that although the register transfer DataIn is performed while setting channels Ch0 to Ch3 (first logical page A) as the compaction destinations in this example, the compaction destinations are not limited to those. After that, at time T2, the compaction target data are transferred to the registers 121, and the register transfer DataIn ends.

At this time, the processing data amount (number of channels) of the register transfer DataIn according to the first embodiment is half of the processing data amount (number of channels) of the register transfer DataIn according to the comparative example. As described above, the data are sequentially read on the channel basis in the register transfer DataIn. For this reason, the time necessary for the register transfer DataIn of the first embodiment (for example, the time from time T1 to T2 in FIG. 9) is half of the time necessary for the register transfer DataIn of the comparative example (for example, the time from time T1 to T2 in FIG. 5).

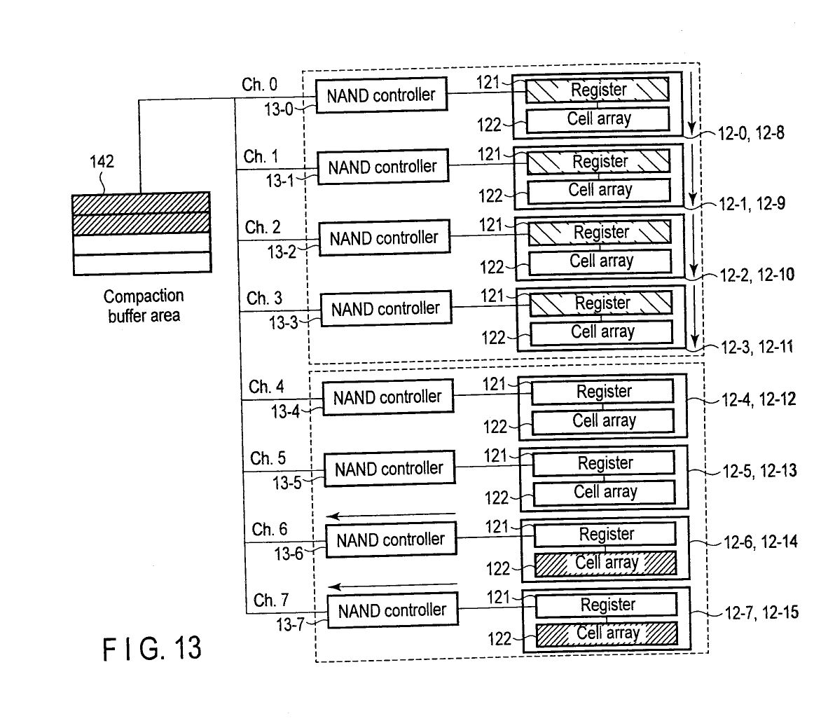

Next, at time T2, the cell array program tProg of the first logical page A of page 0 starts to write the compaction target data transferred to the registers 121 in the cell arrays 122 of NAND memories 12-0 to 12-3 and 12-8 to 12-11 (first logical page A). At this time, the compaction target data are parallelly written in channels Ch0 to Ch3, as shown in FIG. 13. After that, at time T5, the compaction target data are written in the cell arrays, and the cell array program tProg ends. That is, the compaction write CmpWt of the first logical page A of page 0 ends, and the compaction processing of the first logical page A of page 0 ends.

On the other hand, compaction processing of the second logical page B (channels Ch4 to Ch7) of the logical page in page 0 (to be simply referred to as the second logical page B of page 0 hereinafter) is performed from time T1 to T7.

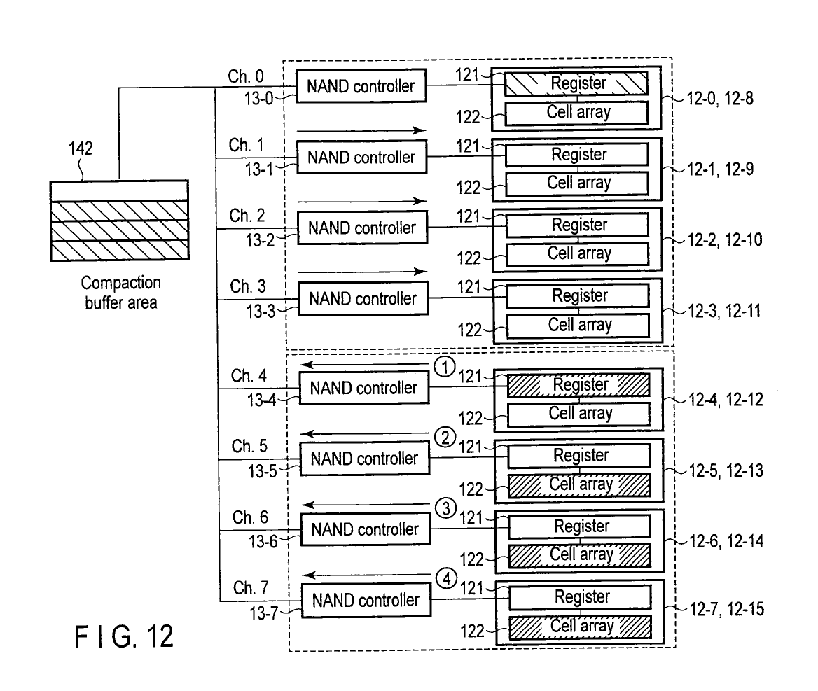

As shown in FIG. 12, when a time Δt has elapsed from time T1, part of the compaction target data of the first logical page A is transferred from the CB area 142 to the register 121 (for example, channel Ch0) of the first logical page A. The CB area 142 is thus partially released. In this way, when the register transfer DataIn of the first logical page A of page 0 starts from time T1, the CB area 142 is sequentially released. Along with the release of the CB area 142, the system control unit 156 acquires the information of the free capacity of the CB area 142 from the data buffer control unit 151.

The system control unit 156 starts the compaction read CmpRd of the second logical page B of page 0 based on a compaction read command transferred from the compaction control unit 155. Compaction target data corresponding to half of one logical page are thus read from NAND memories 12-4 to 12-7 and 12-12 to 12-15 as the compaction sources via NAND controllers 13-4 to 13-7. At this time, the compaction target data are read sequentially in channels Ch4 to Ch7, as shown in FIG. 12. The read compaction target data are temporarily stored in the CB area 142 of the data buffer 14. After that, at time T3, the compaction target data are accumulated in the CB area 142, and the compaction read CmpRd of the second logical page B of page 0 ends.

Sequentially, at time T3, the system control unit 156 starts the compaction write CmpWt of the second logical page B of page 0 based on a compaction write command transferred from the compaction control unit 155.

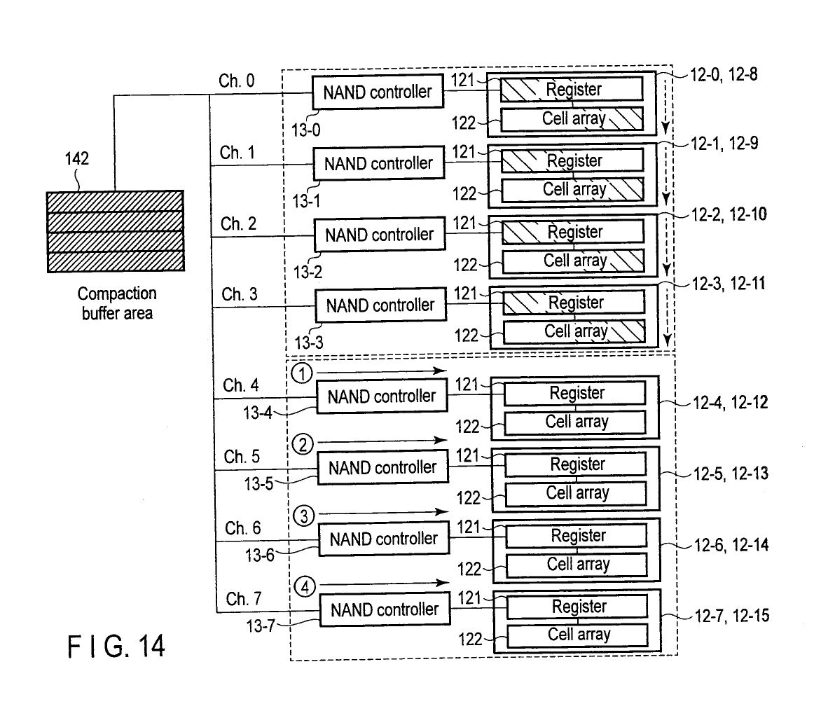

More specifically, at time T3, the register transfer DataIn of the second logical page B of page 0 starts to transfer the compaction target data corresponding to half of one logical page from the CB area 142 to the registers 121 of NAND memories 12-4 to 12-7 and 12-12 to 12-15 (second logical page B) as the compaction destinations via NAND controllers 13-4 to 13-7. At this time, the compaction target data are transferred sequentially in channels Ch4 to Ch7, as shown in FIG. 14. Note that although the register transfer DataIn is performed while setting channels Ch4 to Ch7 (second logical page B) as the compaction destinations in this example, the compaction destinations are not limited to those. After that, at time T4, the compaction target data are transferred to the registers 121, and the register transfer DataIn ends.

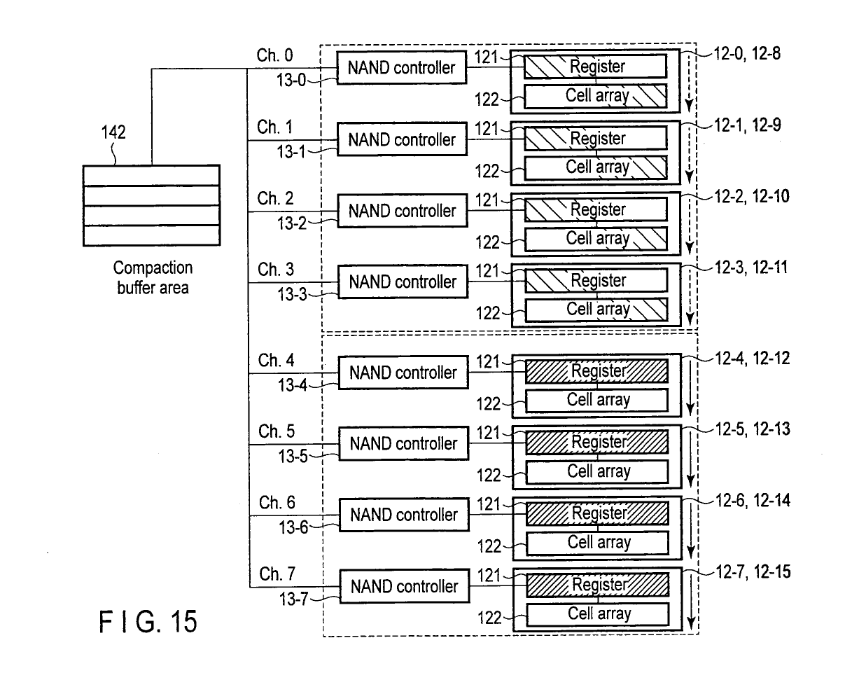

At this time, the CB area 142 is released as the register transfer DataIn of the second logical page B of page 0 ends, as shown in FIG. 15. However, the compaction read CmpRd of the first logical page A of page 1 does not start. The compaction read CmpRd of the first logical page A of page 1 starts after the end (time T5) of the compaction write CmpWt of the first logical page A of page 0.

Next, at time T4, the cell array program tProg of the second logical page B of page 0 starts to write the compaction target data transferred to the registers 121 in the cell arrays 122 of NAND memories 12-4 to 12-7 and 12-12 to 12-15 (second logical page B). At this time, the compaction target data are parallelly written in channels Ch4 to Ch7, as shown in FIG. 15. After that, at time T7, the compaction target data are written in the cell arrays, and the cell array program tProg ends. That is, the compaction write CmpWt of the second logical page B of page 0 ends, and the compaction processing of the second logical page B of page 0 ends.

Next, compaction processing of the first logical page A of page 1 is performed from time T5 to T11, like the first logical page A of page 0.

At time T5, the compaction write CmpWt (cell array program tProg) of the second logical page B of page 0 is progressing. That is, the CB area 142 is released. Along with the release of the CB area 142, the system control unit 156 acquires the information of the free capacity of the CB area 142 from the data buffer control unit 151.

The system control unit 156 starts the compaction read CmpRd of the first logical page A of page 1 based on a compaction read command transferred from the compaction control unit 155. Compaction target data corresponding to half of one logical page are thus read from NAND memories 12-0 to 12-3 and 12-8 to 12-11 as the compaction sources via NAND controllers 13-0 to 13-3 and temporarily stored in the CB area 142 of the data buffer 14. After that, at time T6, the compaction target data are accumulated in the CB area 142, and the compaction read CmpRd of the first logical page A of page 1 ends.

Sequentially, at time T6, the system control unit 156 starts the compaction write CmpWt of the first logical page A of page 1 based on a compaction write command transferred from the compaction control unit 155.

More specifically, at time T6, the register transfer DataIn of the first logical page A of page 1 starts to transfer the compaction target data corresponding to half of one logical page from the CB area 142 to the registers 121 of NAND memories 12-0 to 12-3 and 12-8 to 12-11 as the compaction destinations via NAND controllers 13-0 to 13-3. After that, at time T8, the compaction target data are transferred to the registers 121, and the register transfer DataIn ends.

Next, at time T8, the cell array program tProg of the first logical page A of page 1 starts to write the compaction target data transferred to the registers 121 in the cell arrays 122 of NAND memories 12-0 to 12-3 and 12-8 to 12-11. After that, at time T11, the compaction target data are written in the cell arrays, and the cell array program tProg of the first logical page A of logical page in page 1 ends. That is, the compaction write CmpWt of the first logical page A of page 1 ends, and the compaction processing of the first logical page A of page 1 ends.

After that, compaction processing of the first logical page A of logical page in page 2 and sequential pages is performed in a similar manner.

On the other hand, compaction processing of the second logical page B of page 1 is performed from time T7 to T12, like the second logical page B of page 0.

At time T7 (after the elapse of the time Δt from time T6), part of the compaction target data of the first logical page A is transferred from the CB area 142 to the register 121 (for example, channel Ch0) of the first logical page A. The CB area 142 is thus partially released. In this way, when the register transfer DataIn of the first logical page A of page 1 starts from time T6, the CB area 142 is sequentially released. Along with the release of the CB area 142, the system control unit 156 acquires the information of the free capacity of the CB area 142 from the data buffer control unit 151.

The system control unit 156 starts the compaction read CmpRd of the second logical page B of page 1 based on a compaction read command transferred from the compaction control unit 155. Compaction target data corresponding to half of one logical page are thus read from NAND memories 12-4 to 12-7 and 12-12 to 12-15 as the compaction sources via NAND controllers 13-4 to 13-7, and temporarily stored in the CB area 142 of the data buffer 14. After that, at time T9, the compaction target data are accumulated in the CB area 142, and the compaction read CmpRd of the second logical page B of page 1 ends.

Sequentially, at time T9, the system control unit 156 starts the compaction write CmpWt of the second logical page B of logical page in page 1 based on a compaction write command transferred from the compaction control unit 155.

More specifically, at time T9, the register transfer DataIn of the second logical page B of page 1 starts to transfer the compaction target data corresponding to half of one logical page from the CB area 142 to the registers 121 of NAND memories 12-4 to 12-7 and 12-12 to 12-15 as the compaction destinations via NAND controllers 13-4 to 13-7. After that, at time T10, the compaction target data are transferred to the registers 121, and the register transfer DataIn of the second logical page B of page 1 ends.

Next, at time T10, the system control unit 156 starts the cell array program tProg of the second logical page B of page 1 to write the compaction target data transferred to the registers 121 in the cell arrays 122 of NAND memories 12-4 to 12-7 and 12-12 to 12-15. After that, at time T12, the compaction target data are written in the cell arrays, and the cell array program tProg of the second logical page B of page 1 ends. That is, the compaction write CmpWt of the second logical page B of page 1 ends, and the compaction processing of the second logical page B of page 1 ends.

After that, compaction processing of the second logical page B of logical page in page 2 and sequential pages is performed in a similar manner.

As described above, in the first embodiment, from time T1 to T3, the compaction read CmpRd of the second logical page B of page 0 is performed simultaneously in parallel to the compaction write CmpWt of the first logical page A of page 0. In addition, from time T5 to T6, the compaction read CmpRd of the first logical page A of page 1 is performed simultaneously in parallel to the compaction write CmpWt of the second logical page B of page 0.

### [Effects]

According to the above-described first embodiment, in the memory system 10, the logical page management unit 154 divides a logical page into the first logical page A and the second logical page B along the channel direction. The system control unit 156 performs compaction processing for each logical page divided by the logical page management unit 154 based on a compaction command generated by the compaction control unit 155.

This makes it possible to perform processing while at least partially overlapping the compaction read CmpRd of the first logical page A and the compaction write CmpWt of the second logical page B, and the compaction write CmpWt of the first logical page A and the compaction read CmpRd of the second logical page B. That is, it is possible to execute so-called pipeline processing of overlapping a plurality of instructions between the first logical page A and the second logical page B. This allows to obtain the following effects. The pipeline processing indicates simultaneously parallelly processing at least some of a plurality of serial processing elements that are arranged such that the output of a processing element becomes the input of the next processing element.

Dividing a logical page into the first logical page A and the second logical page B along the channel direction enables to decrease the processing data amount of compaction processing. This allows to shorten the processing time necessary for the compaction read CmpRd and the register transfer DataIn in which data are transferred between the NAND memories 12 and the CB area 142. In addition, since the amount of data stored in the CB area 142 at once by the compaction read CmpRd decreases, the capacity of the CB area 142 can be reduced. More specifically, the capacity of the CB area 142 need only be equal to or larger than the capacity of four first logical pages A (second logical pages B) and may be smaller than the capacity for one logical page.

Note that in the first embodiment, the logical page is divided into a predetermined number of channels Ch, and compaction processing is performed for each of the divided logical pages. The write operation and the read operation by the host may similarly be performed. In this case, since the amount of data stored in the WB area 141 at once by the write operation and the read operation by the host decreases, the capacity of the WB area 141 can be reduced.

### Second Embodiment

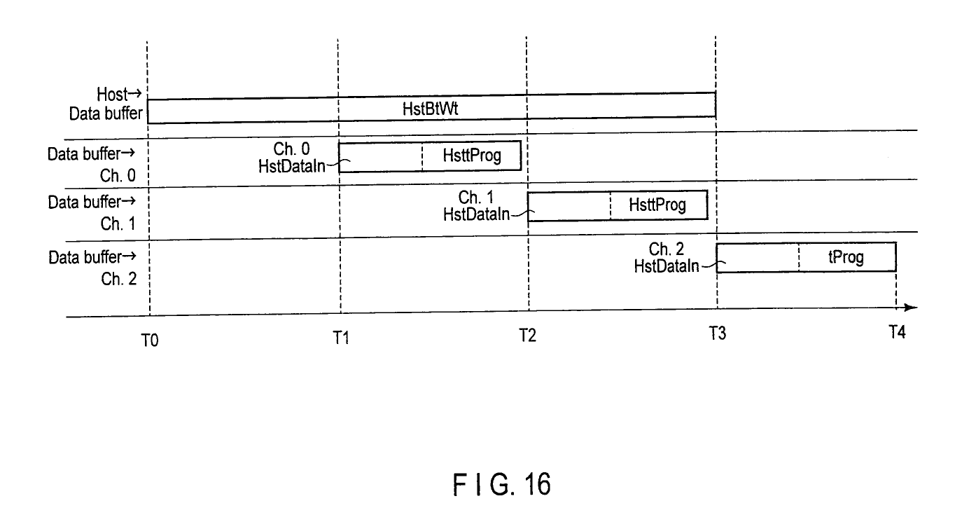

A memory system according to the second embodiment will be described with reference to FIGS. 16, 17, 18, and 19. In the second embodiment, when write data from a host are accumulated in a WB area 141 for each channel Ch, the data are sequentially transferred from the WB area 141 to the channel Ch in a write operation (host write) by the host. The second embodiment will be described below in detail. Note that in the second embodiment, a description of the same points as the in first embodiment will be omitted, and different points will mainly be explained.

### [Host Write]

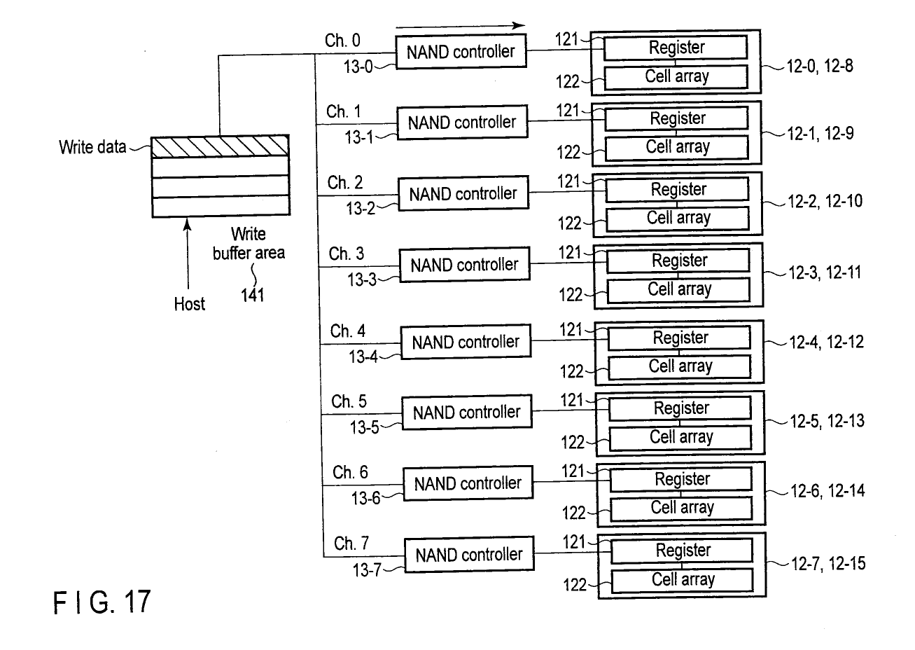

FIG. 16 is a timing chart showing host write according to the second embodiment. FIGS. 17, 18, and 19 are schematic views showing a memory system so as to explain the host write according to the second embodiment. In the second embodiment, the host write includes host buffer write HstBfWt of transferring write data from the host to the WB area 141 and host memory write (host register transfer HstDataIn and host cell array program) of transferring the write data from the WB area 141 to NAND memories 12-0 to 12-15.

Note that times T0 to T4 in FIG. 16 are not necessarily the same as times T0 to T4 in FIG. 5.

As shown in FIG. 16, at time T0, a system control unit 156 starts host write based on a host write command transferred from the host. More specifically, at time T0, the host buffer write HstBfWt of transferring write data from the host to a data buffer 14 (WB area 141) starts. The host buffer write HstBfWt continues until all write data are transferred to the WB area 141.

After that, at time T1, write data to a channel Ch0 are accumulated in the WB area 141. At the same time, host memory write from the WB area 141 to channel Ch0 starts, as shown in FIG. 17.

That is, at time T1, the host register transfer HstDataIn of channel Ch0 starts to transfer the write data from the WB area 141 to registers 121 of NAND memories 12-0 and 12-8 via a NAND controller 13-0. After that, the host register transfer HstDataIn of channel Ch0 ends. Sequentially, a host cell array program HsttProg of channel Ch0 starts to write the write data transferred to the registers 121 in cell arrays 122 of NAND memories 12-0 and 12-8. After that, the host cell array program HsttProg of channel Ch0 ends, and the host memory write to channel Ch0 ends.

At this time, the host buffer write HstBfWt is progressing. That is, the host memory write to channel Ch0 and the host buffer write HstBfWt are simultaneously performed in parallel.

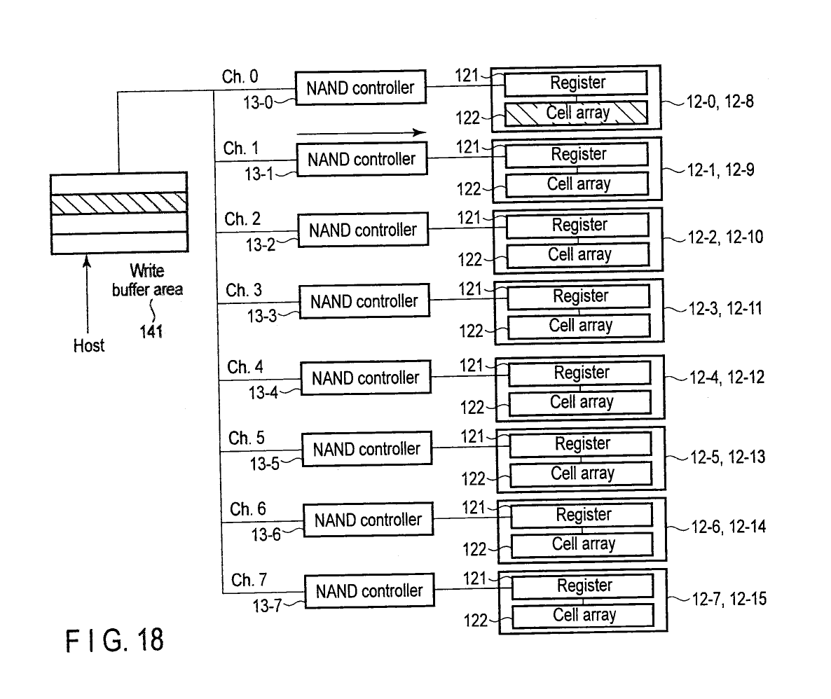

At time T2, write data to a channel Ch1 are accumulated in the WB area 141. At the same time, host memory write from the WB area 141 to channel Ch1 starts, as shown in FIG. 18.

That is, at time T2, the host register transfer HstDataIn of channel Ch1 starts to transfer the write data from the WB area 141 to the registers 121 of NAND memories 12-1 and 12-9 via a NAND controller 13-1. After that, the host register transfer HstDataIn of channel Ch1 ends. Sequentially, the system control unit 156 starts the host cell array program HsttProg of channel Ch1 to write the write data transferred to the registers 121 in the cell arrays 122 of NAND memories 12-1 and 12-9. After that, the host cell array program HsttProg of channel Ch1 ends, and the host memory write to channel Ch1 ends.

At this time, the host buffer write HstBfWt is progressing. That is, the host memory write to channel Ch1 and the host buffer write HstBfWt are simultaneously performed in parallel.

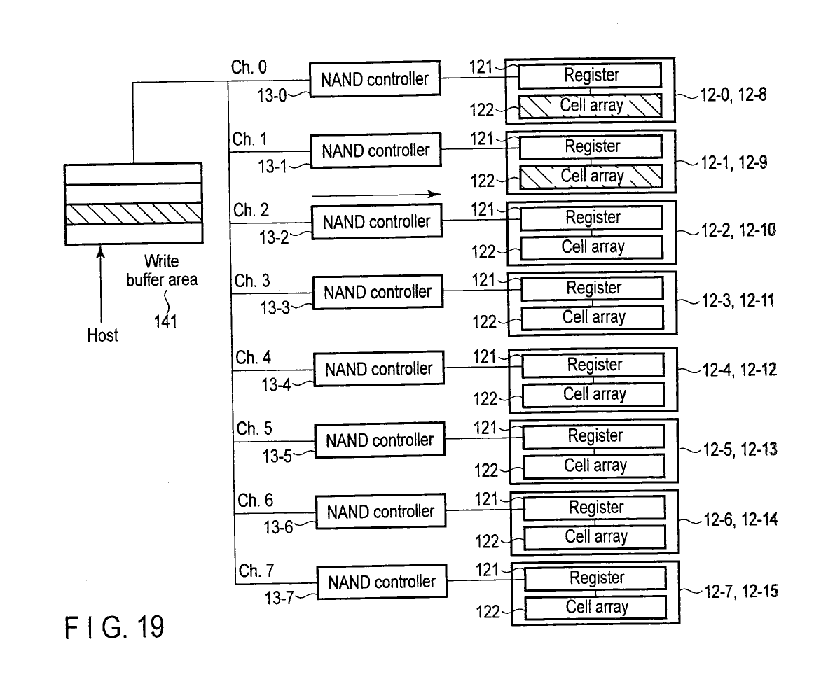

At time T3, write data to a channel Ch2 are accumulated in the WB area 141, and the host buffer write HstBfWt ends. At the same time, host memory write from the WB area 141 to channel Ch2 starts, as shown in FIG. 19.

That is, at time T3, the host register transfer HstDataIn of channel Ch2 starts to transfer the write data from the WB area 141 to the registers 121 of NAND memories 12-2 and 12-10 via a NAND controller 13-2. After that, the host register transfer HstDataIn of channel Ch2 ends. Sequentially, the system control unit 156 starts the host cell array program HsttProg of channel Ch2 to write the write data transferred to the registers 121 in the cell arrays 122 of NAND memories 12-2 and 12-10. After that, at time T4, the host cell array program HsttProg of channel Ch2 ends, and the host memory write to channel Ch2 ends.

The host write according to the second embodiment thus ends.

### [Effects]

According to the above-described second embodiment, in the host write, host memory write is performed to sequentially transfer write data from the WB area 141 to the channel Ch when the write data from the host are accumulated in the WB area 141 for each channel Ch by the host buffer write HstBfWt. The host buffer write HstBfWt of the next channel Ch is performed even during the host memory write. That is, the host buffer write HstBfWt and the host memory write can be overlapped. This allows to shorten the processing time of host write. It is also possible to reduce the capacity of the WB area 141.

### Third Embodiment

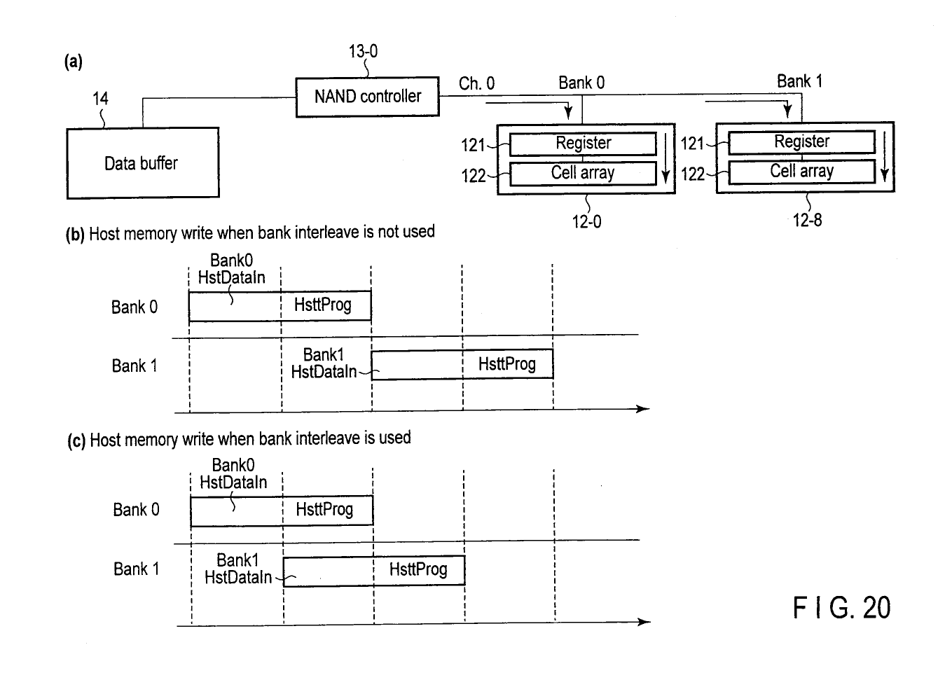

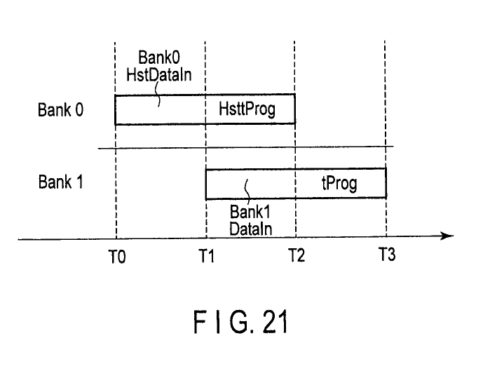

A memory system according to the third embodiment will be described with reference to FIGS. 20 and 21. In the third embodiment, when a channel Ch has a plurality of banks Bank 0 and Bank 1, host write (host memory write) and compaction write are overlapped between the banks. The third embodiment will be described below in detail. Note that in the third embodiment, a description of the same points as the in first embodiment will be omitted, and different points will mainly be explained.

### [Bank Interleave]

FIG. 20 is a view for explaining the mechanism of bank interleave according to the third embodiment. More specifically, FIG. 20(a) is a schematic view showing the memory system so as to explain bank interleave. FIG. 20(b) is an example of a timing chart of host write (host memory write) when bank interleave is not used. FIG. 20(c) is an example of a timing chart of host write (host memory write) when bank interleave is used.

Bank interleave according to this embodiment indicates dividing NAND memories 12-0 to 12-15 into a plurality of banks and parallelly performing data transfer to/from a peripheral device (for example, data buffer 14) in each bank. This will be described below in more detail.

In this example, a channel Ch0 (NAND memories 12-0 and 12-8) is divided into the two banks Bank 0 and Bank 1, as shown in FIG. 20(a). Each of Bank 0 and Bank 1 (NAND memories 12-0 and 12-8) is provided with a cell array 122 and a register 121 that temporarily stores data.

As shown in FIG. 20(b), when bank interleave is not used, host register transfer HstDataIn is first performed to transfer data stored in the data buffer 14 (WB area 141) to the register 121 of NAND memory 12-0 of Bank 0. Next, a host cell array program HsttProg is performed to write, in the cell array, the data transferred to the register 121 of NAND memory 12-0 of Bank 0. Sequentially, the host register transfer HstDataIn is performed to transfer data stored in the data buffer 14 (WB area 141) to the register 121 of NAND memory 12-8 of Bank 1. Next, the host cell array program HsttProg is performed to write, in the cell array, the data transferred to the register 121 of NAND memory 12-8 of Bank 1.

As described above, when bank interleave is not used, the host register transfer HstDataIn and the host cell array program HsttProg are sequentially performed in each of Bank 0 and Bank 1.

Conversely, as shown in FIG. 20(c), when bank interleave is used, the host register transfer HstDataIn is first performed to transfer data stored in the data buffer 14 (WB area 141) to the register 121 of NAND memory 12-0 of Bank 0. Next, the host cell array program HsttProg is performed to write, in the cell array, the data transferred to the register 121 of NAND memory 12-0 of Bank 0. At this time, the host register transfer HstDataIn is simultaneously performed to transfer data stored in the data buffer 14 (WB area 141) to the register 121 of NAND memory 12-8 of Bank 1. After that, the host cell array program HsttProg is performed to write, in the cell array, the data transferred to the register 121 of NAND memory 12-8 of Bank 1.

As described above, when bank interleave is used, the host cell array program HsttProg in Bank 0 and the host register transfer HstDataIn in 1 are simultaneously performed (overlapped) in parallel. This allows to do high-speed write in the plurality of banks Bank 0 and Bank 1 of the same channel Ch.

Note that although data write has been exemplified above, this also applies to data read.

### [Host Write and Compaction Write]

FIG. 21 is a timing chart showing host write and compaction write using bank interleave according to the third embodiment. Note that times T0 to T3 in FIG. 20 are not necessarily the same as times T0 to T3 in FIG. 5.

As shown in FIG. 21, the host register transfer HstDataIn starts to transfer data stored in the data buffer 14 (WB area 141) to the register 121 of NAND memory 12-0 of Bank 0. After that, at time T1, the host register transfer HstDataIn in Bank 0 ends.

Sequentially, at time T1, the host cell array program HsttProg starts to write, in the cell array, the data transferred to the register 121 of NAND memory 12-0 of Bank 0.

At this time, register transfer DataIn starts to transfer data stored in the data buffer 14 (CB area 142) to the register 121 of NAND memory 12-8 of Bank 1. That is, compaction write of bank Bank 1 is performed during host write of bank Bank 0.

After that, at time T2, a cell array program tProg is performed to write, in the cell array, the data transferred to the register 121 of NAND memory 12-8 of Bank 1.

As described above, when bank interleave is used, the host cell array program HsttProg in Bank 0 and the register transfer DataIn of compaction write in 1 are simultaneously performed (overlapped) in parallel.

### [Effects]

According to the above-described third embodiment, host write (host memory write) and compaction write are overlapped between the plurality of banks Bank 0 and Bank 1 capable of bank interleave. This allows to appropriately perform host write and compaction write in the plurality of banks Bank 0 and Bank 1 in the same channel Ch. In addition, overlapping the processes enables high-speed processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a storage areas each having a physical page that is data-write- and read-accessible, the storage areas being divided into a plurality of parallel operation elements capable of performing a parallel operation, and the physical pages of the storage areas being associated with a logical page;
a storage unit having a buffer configured to store data to be rewritten in the storage areas; and
a control unit configured to perform data transfer between the storage areas and the storage unit,
wherein the control unit comprises:
a logical page management unit configured to divide the logical page into a first logical page and a second logical page in a predetermined number of parallel operation elements out of the plurality of parallel operation elements and manage the logical pages;
a compaction control unit configured to generate a write command and a read command in compaction processing; and
a system control unit configured to perform a read operation in the compaction processing of the second logical page when performing a write operation in the compaction processing of the first logical page and perform the read operation in the compaction processing of the first logical page when performing the write operation in the compaction processing of the second logical page based on the write command and the read command in the compaction processing.

2. A memory system comprising:
a storage areas each having a physical page that is data-write- and read-accessible, the storage areas being divided into a plurality of parallel operation elements capable of performing a parallel operation, and the physical pages of the storage areas being associated with a logical page;
a storage unit having a buffer configured to store data to be rewritten in the storage areas; and
a control unit configured to perform data transfer between the storage areas and the storage unit,
wherein the control unit comprises:
a logical page management unit configured to divide the logical page in a predetermined number of parallel operation elements out of the plurality of parallel operation elements;
a compaction control unit configured to generate a write command and a read command in compaction processing; and
a system control unit configured to perform a write operation and a read operation in the compaction processing at least partially simultaneously in parallel between the divided logical pages based on the write command and the read command in the compaction processing.

3. A memory system comprising:
a storage areas each having a physical page that is data-write- and read-accessible, the storage areas being divided into a plurality of parallel operation elements capable of performing a parallel operation, and the physical pages of the storage areas being associated with a logical page;
a storage unit having a first buffer configured to store data to be rewritten in the storage areas; and
a control unit configured to perform data transfer between the storage areas and the storage unit,
wherein the control unit comprises:
a logical page management unit configured to divide the logical page in a predetermined number of parallel operation elements out of the plurality of parallel operation elements; and
a system control unit configured to perform a predetermined operation in each of the divided logical pages.

4. The system of claim 3, wherein the system control unit performs processing at least partially simultaneously in parallel between the divided logical pages.

5. The system of claim 3, wherein the control unit further comprises a compaction control unit configured to generate a write command and a read command in compaction processing.

6. The system of claim 5, wherein the system control unit performs a write operation and a read operation in the compaction processing in each of the divided logical pages based on the write command and the read command in the compaction processing.

7. The system of claim 6, wherein the logical page management unit divides the logical page into a first logical page and a second logical page in a predetermined number of parallel operation elements out of the plurality of parallel operation elements, and
the system control unit performs the read operation in the compaction processing of the second logical page when performing the write operation in the compaction processing of the first logical page and performs the read operation in the compaction processing of the first logical page when performing the write operation in the compaction processing of the second logical page.

8. The system of claim 7, wherein the system control unit starts the write operation in the compaction processing of the first logical page at an end of the read operation in the compaction processing of the first logical page, starts the read operation in the compaction processing of the second logical page after the start of the write operation in the compaction processing of the first logical page, and starts the write operation in the compaction processing of the second logical page at an end of the read operation in the compaction processing of the second logical page.

9. The system of claim 6, wherein the control unit further comprises a data buffer control unit configured to manage a free capacity of the first buffer.

10. The system of claim 9, wherein the system control unit performs the read operation in the compaction processing in accordance with acquisition of information of the free capacity of the first buffer.

11. The system of claim 6, further comprising a controller connected to each of the plurality of parallel operation elements and configured to perform interface processing between the plurality of parallel operation elements and the first buffer and the control unit.

12. The system of claim 6, wherein in the read operation in the compaction processing, compaction target data of the divided logical page is transferred from the storage areas to the first buffer, and in the write operation in the compaction processing, the compaction target data is transferred from the first buffer to the storage areas.

13. The system of claim 12, wherein in the write operation in the compaction processing, the compaction target data is transferred from the first buffer to registers of the storage areas, and the compaction target data is written from the registers to cell arrays of the storage areas.

14. The system of claim 12, wherein the read operation in the compaction processing is sequentially performed for one of the plurality of parallel operation elements.

15. The system of claim 12, wherein transfer of the compaction target data from the first buffer to the registers of the storage areas is sequentially performed for one of the plurality of parallel operation elements.

16. The system of claim 6, wherein a capacity of the first buffer is not less than that of the predetermined number of parallel operation elements and smaller than that of the plurality of parallel operation elements.

17. The system of claim 3, wherein the storage unit further comprises a second buffer configured to temporarily store data exchanged between a host and the storage areas.

18. The system of claim 17, wherein the system control unit performs a write operation and a read operation by the host in each of the divided logical pages based on a write command and a read command from the host.
